(19) United States
(12) Patent Application Publication
(10) Pub. No.: US 2025/0196009 A1
(43) Pub. Date: Jun. 19, 2025

(54) IMAGE PROCESSING METHOD AND APPARATUS, DEVICE, AND STORAGE MEDIUM

(71) Applicant: Beijing Zitiao Network Technology Co., Ltd., Beijing (CN)

(72) Inventors: Jiaxin MA, Beijing (CN); Liyou XU, Beijing (CN); Siyuan WANG, Beijing (CN)

(21) Appl. No.: 18/852,285

(22) PCT Filed: Mar. 7, 2023
(86) PCT No.: PCT/CN2023/079968

§ 371 Date: Sep. 27, 2024

(30) Foreign Application Priority Data
Mar. 29, 2022 (CN) 202210325298.8

(51) Int. Cl. A63F 13/577; A63F 13/573

(52) U.S. Cl. CPC A63F 13/577; A63F 13/573

(57) ABSTRACT

Embodiments of the present disclosure disclose an image processing method and apparatus, a device, and a storage medium. A line collider is generated according to a drawing trajectory triggered by a user in a screen corresponding to a current scene, in which the current scene includes a plurality of virtual colliders, and the line collider includes a plurality of box colliders with a set shape; the line collider and a first virtual collider in the current scene are controlled to move in a set manner; whether at least one selected from the group consisting of the line collider and the first virtual collider collides with a second virtual collider is detected; in response to collision, a first result is generated; and in response to no collision, a second result is generated.

The present disclosure claims priority to Chinese Patent Application No. 202210325298.8 filed in China Patent Office on Mar. 29, 2022, the entire disclosure of which is incorporated herein by reference as part of the present application.

### TECHNICAL FIELD

Embodiments of the present disclosure relate to a technical field of image processing, and for example, to an image processing method and apparatus, a device, and a storage medium.

### BACKGROUND

In an electronic game developed based on a set game engine, for virtual objects that may collide, a collider is usually set on each virtual object to detect whether collision happens.

In a game in the related art, most of generated colliders are colliders having certain shapes, but a collider with a line shape cannot be generated, which limits the diversified development of games.

### SUMMARY

The embodiments of the present disclosure provide an image processing method and apparatus, a device, and a storage medium to realize processing of line colliders and improve the diversity of game development.

In a first aspect, an image processing method is provided by embodiments of the present disclosure. This method includes:
generating a line collider according to a drawing trajectory triggered by a user in a screen corresponding to a current scene, wherein the current scene includes a plurality of virtual colliders, and the line collider is constituted by a plurality of box colliders with a set shape;
controlling the line collider and a first virtual collider in the current scene to move in a set manner;
detecting whether at least one selected from the group consisting of the line collider and the first virtual collider collides with a second virtual collider; and
generating a first result in response to the at least one selected from the group consisting of the line collider and the first virtual collider colliding with the second virtual collider, and generating a second result in response to the at least one selected from the group consisting of the line collider and the first virtual collider not colliding with the second virtual collider.

In a second aspect, an image processing apparatus is also provided by embodiments of the present disclosure. This apparatus includes:
a line collider generation module, configured to generate a line collider according to a drawing trajectory triggered by a user in a screen corresponding to a current scene; the current scene includes a plurality of virtual colliders, and the line collider is constituted by a plurality of box colliders with a set shape;
a motion control module, configured to control the line collider and a first virtual collider in the current scene to move in a set manner;
a collision detection module, configured to detect whether at least one selected from the group consisting of the line collider and the first virtual collider collides with a second virtual collider; and
a result generation module, configured to generate a first result in response to the at least one selected from the group consisting of the line collider and the first virtual collider colliding with the second virtual collider, and generate a second result in response to the at least one selected from the group consisting of the line collider and the first virtual collider not colliding with the second virtual collider.

In a third aspect, an electronic device is also provided by embodiments of the present disclosure. This electronic device includes:
a processing apparatus; and
a storage apparatus, configured to store a program,
the program, when executed by the processing apparatus, causes the processing apparatus to implement the image processing method according to the embodiments of the present disclosure.

In a fourth aspect, a computer-readable medium is also provided by embodiments of the present disclosure. This computer-readable medium stores a computer program; the computer program, when executed by a processing apparatus, causes to implement the image processing method according to the embodiments of the present disclosure.

### BRIEF DESCRIPTION OF DRAWINGS

FIG. 1 is a flowchart of an image processing method provided by an embodiment of the present disclosure;

FIG. 2 is an example diagram of generating a line collider provided by an embodiment of the present disclosure;

FIG. 3 is an example diagram of a scene provided by an embodiment of the present disclosure;

FIG. 4 is a schematic structural diagram of an image processing apparatus provided by an embodiment of the present disclosure; and

FIG. 5 is a schematic structural diagram of an electronic device provided by an embodiment of the present disclosure.

### DETAILED DESCRIPTION

Embodiments of the present disclosure are described below with reference to the drawings. Although certain embodiments of the present disclosure are shown in the drawings, it should be understood that the present disclosure may be achieved in various forms and should not be construed as being limited to the embodiments described here. It should be understood that the drawings and the embodiments of the present disclosure are only for exemplary purposes.

It should be understood that various steps recorded in the implementation modes of the method of the present disclosure may be performed according to different orders and/or performed in parallel. In addition, the implementation modes of the method may include additional steps and/or steps omitted or unshown.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among a plurality of apparatuses in embodiments of the present disclosure are only used for the illustrative purpose and are not used to limit the scope of these messages or information.

The solutions of the present embodiments may be applied to a game scene. The game includes a plurality of levels, and each level corresponds to a scene. A plurality of virtual colliders are arranged in each scene, and the virtual colliders may be static colliders or dynamic colliders. The virtual colliders may be fixed at a set position. The dynamic colliders may move in the scene of the current level in a set way, and may collide with other virtual colliders in the motion process.

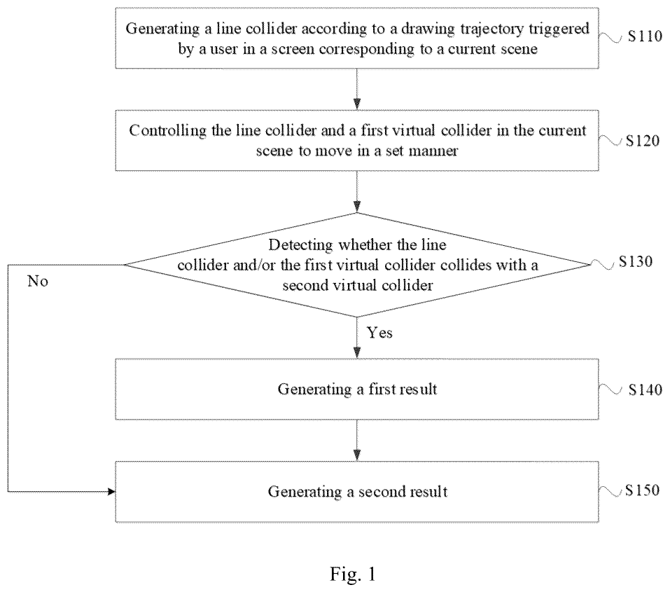

FIG. 1 is a flowchart of an image processing method provided by embodiment I of the present disclosure. This embodiment may be applicable to a case where collision of a line collider is processed. The image processing method may be performed by an image processing apparatus which may be composed of hardware and/or software, and may be generally integrated into a device with an image processing function. The device may be an electronic device such as a server, a mobile terminal, or a server cluster. As shown in FIG. 1, the image processing method may include the following steps.

S110: generating a line collider according to a drawing trajectory triggered by a user in a screen corresponding to a current scene.

For example, the current scene includes a plurality of virtual colliders. The current scene may be a scene corresponding to one of the levels in a game scene. The line collider is constituted by a plurality of box colliders with a set shape.

In this embodiment, when the user enters the current scene corresponding to a game level through an entertainment application (APP), in the current scene, the APP displays a task needing to be completed at this level through text information, and the user starts to draw lines on the touch screen according to task prompts. After the user completes the drawing, the line collider is generated based on the obtained drawing trajectory.

Optionally, the process of generating the line collider according to the drawing trajectory triggered by the user in the screen corresponding to the current scene may be as follows: when a drawing time reaches a timing end time, generating the line collider according to the drawing trajectory completed by the user in the screen corresponding to the current scene; or, when it is detected that the user stops drawing, generating the line collider according to the drawing trajectory completed by the user in the screen corresponding to the current scene.

For example, stopping drawing may be performed upon detecting that the user lifts a finger away from the screen or detecting that the user's finger is stopped at a position without moving. Exemplarily, when entering the current scene, a drawing countdown is started (e.g., 10 seconds), and the user starts to draw lines on the touch screen. When the countdown ends or the user stops drawing, the completed drawing trajectory is obtained, and the line collider is generated according to the completed drawing trajectory. In this embodiment, the countdown is started for drawing, and the line collider is generated according to the drawing trajectory completed by the user in the screen corresponding to the current scene, so that the accuracy of the generated line collider can be improved.

Optionally, a way of generating the line collider according to the drawing trajectory triggered by the user in the screen corresponding to the current scene may be as follows: obtaining touch points of every two adjacent frames of the user in the drawing process as a first touch-screen point and a second touch-screen point; taking the first touch-screen point and the second touch-screen point as two vertices with a set shape to generate a box collider with the set shape, and obtaining a plurality of box colliders; and connecting the plurality of box colliders in series to obtain the line collider.

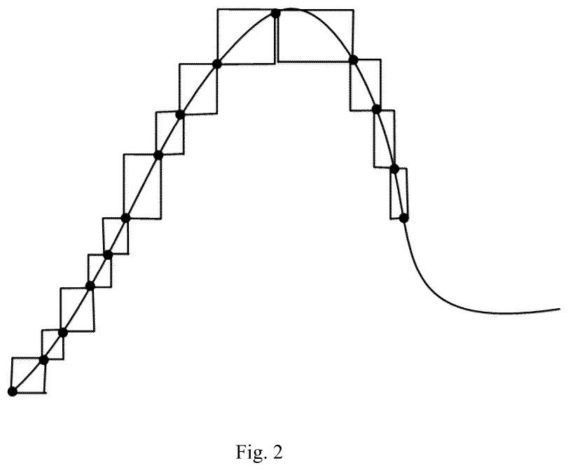

In one embodiment, the set shape may be a rectangle, and the first touch-screen point and the second touch-screen point may be two vertices on a diagonal of the rectangle. Exemplarily, the first touch-screen point and the second touch-screen point are used as two vertices of the diagonal to generate a rectangular collider, so that a plurality of rectangular colliders are connected together in series to form the line collider. Exemplarily, FIG. 2 is an example diagram of generating the line collider in this embodiment. As shown in FIG. 2, touch-screen points on the drawing trajectory are obtained, and adjacent touch points are taken as diagonal vertices of a rectangle to generate the rectangular collider. A plurality of rectangular colliders are connected in series to generate the line collider. In this embodiment, the plurality of rectangular colliders are connected in series to generate the line collider, so that collision detection can be performed on the line collider.

Optionally, a way of taking the first touch-screen point and the second touch-screen point as the two vertices with the set shape to generate the box collider with the set shape may be as follows: when a transverse distance between the first touch-screen point and the second touch-screen point is greater than a set proportion of a transverse length of the screen, and/or, when a longitudinal distance between the first touch-screen point and the second touch-screen point is greater than a set proportion of a longitudinal length of the screen, inserting a touch-screen point between the first touch-screen point and the second touch-screen point; and generating the box collider with the set shape based on two adjacent touch-screen points after point insertion.

In one embodiment, the set proportion may be set to any value between 0.03 and 0.05. For example, the set proportion may be set to 0.04. In this embodiment, when the user draws at a high speed on the screen, the transverse distance between the first touch-screen point and the second touch-screen point may be caused to be greater than the set proportion of the transverse length (width) of the screen and/or the longitudinal distance between the first touch-screen point and the second touch-screen point may be caused to be greater than the set proportion of the longitudinal length (height) of the screen.

A way of inserting the touch-screen point between the first touch-screen point and the second touch-screen point may be as follows: inserting the touch-screen point based on the transverse distance in units of the set proportion of the transverse length of the screen and the longitudinal distance in units of the set proportion of the longitudinal length of the screen, so that the transverse distance between two adjacent touch points after point insertion is less than or equal to the set proportion of the transverse length of the screen and the longitudinal distance is less than or equal to the set proportion of the longitudinal length of the screen. In this embodiment, the touch-screen point is inserted between the first touch-screen point and the second touch-screen point, so that the size of the generated rectangular collider matches the lines.

Optionally, the way of inserting the touch-screen point between the first touch-screen point and the second touch-screen point may be as follows: acquiring a connecting line between the first touch-screen point and the second touch-screen point; and inserting at least one touch-screen point on the connecting line by adopting a set standard.

Among them, the set standard is that the transverse distance between adjacent touch-screen points is less than or equal to the set proportion of the transverse length of the screen and a longitudinal distance between adjacent touch-screen points is less than or equal to the set proportion of the longitudinal length of the screen. Exemplarily, the process of inserting the at least one touch-screen point on the connecting line may be as follows: firstly, calculating a diagonal length of a rectangle formed with the set proportion of the transverse length of the screen as a width and the set proportion of the longitudinal length of the screen as a height, and then dividing the connecting line between the first touch-screen point and the second touch-screen point in units of the diagonal length, thereby realizing the insertion of the touch-screen point. In this embodiment, the touch-screen point is inserted on the connecting line between the first touch-screen point and the second touch-screen point so that the smoothness of the generated line collider can be guaranteed.

Optionally, when the generated box collider exceeds a set value (e.g., 200), the generation of the box collider is stopped. The performance of the line collider can be improved.

Optionally, the way of generating the line collider according to the drawing trajectory triggered by the user in the screen corresponding to the current scene may be as follows: when the drawing trajectory passes through a virtual collider in the current scene, acquiring an overlapping area between the drawing trajectory and the virtual collider; and skipping over the overlapping area when generating the box collider with the set shape.

In this embodiment, when the drawing trajectory passes through the virtual collider in the current scene, the box collider is no longer generated within the virtual collider. Such a setting may prevent the generated collider from shaking violently during collision, which will affect the game effect.

S120: controlling the line collider and a first virtual collider in the current scene to move in a set manner.

For example, the first virtual collider may be a dynamic collider in the current scene and may be generated by setting a collider on a virtual object. The virtual object may be set based on a requirement of the current scene. For example, the virtual object may be a virtual stone, a virtual bomb, a virtual bullet, or the like. The set manner may be to set a force field in the current scene, so that the line collider and the first virtual collider move under the action of the force field. Exemplarily, the set force field may be a gravity field, so that the line collider and the first virtual collider perform free falling motion.

S130: detecting whether at least one selected from the group consisting of the line collider and the first virtual collider collides with a second virtual collider; if yes, S140 is executed; and if no, S150 is executed.

For example, the second virtual collider may be a static or dynamic collider in the current scene and may be generated by setting a collider on a virtual image. The virtual image may be, for example, an animation image, an animal image, or the like.

Optionally, a way of generating the second virtual collider may be as follows: fusing an image with the second virtual collider to obtain a new second virtual collider.

Among them, the image is a static image or a dynamic image. The static image may be obtained from a local database or a server database. The dynamic image may be a recorded video or a real-time captured image. In this embodiment, when the user starts the entertainment APP, a camera of a terminal device is started and the camera collects a current picture (e.g., a user face) in real time, and the collected image is fused with the second virtual collider to obtain the new second virtual collider. In this embodiment, the image is fused with the second virtual collider, which can improve the interest.

In this embodiment, during the motion process of the line collider and the first virtual collider, before the line collider collides with the first virtual collider, the at least one selected from the group consisting of the line collider and the first virtual collider collides with the second virtual collider; or, after the line collider collides with the first virtual collider, the at least one selected from the group consisting of the line collider and the first virtual collider collides with the second virtual collider.

Optionally, a way of detecting whether the at least one selected from the group consisting of the line collider and the first virtual collider collides with the second virtual collider may be as follows: detecting whether the at least one selected from the group consisting of the line collider and the first virtual collider collides with the second virtual collider within a set duration.

In this embodiment, when the line collider and the first virtual collider start to move, a countdown (e.g., 5 seconds) is performed, and whether the at least one selected from the group consisting of the line collider and the first virtual collider collides with the second virtual collider within the set duration is detected before the countdown ends. By using the countdown method, the interest can be improved.

Optionally, the process of detecting whether the at least one selected from the group consisting of the line collider and the first virtual collider collides with the second virtual collider may be as follows: when the line collider collides with the first virtual collider, determining a first motion trajectory of the line collider after collision and a second motion trajectory of the first virtual collider after the collision; controlling the line collider to continue moving according to the first motion trajectory, and controlling the first virtual collider to continue moving according to the second motion trajectory; and detecting whether the at least one selected from the group consisting of the line collider and the first virtual collider collides with the second virtual collider after continuing to move.

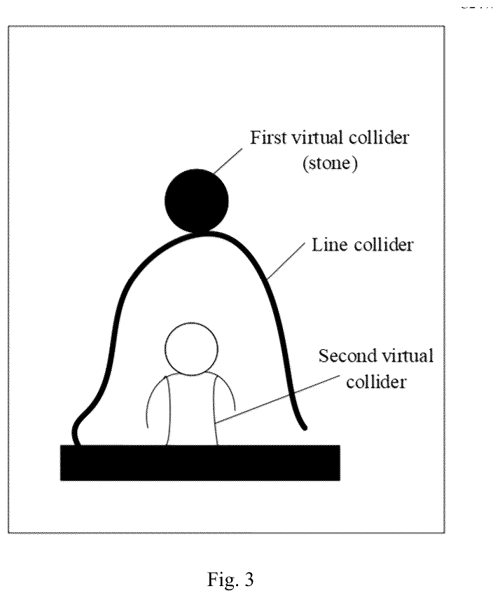

In this embodiment, a way of determining the first motion trajectory of the line collider after the collision and the second motion trajectory of the first virtual collider after the collision may be as follows: after the line collider collides with the first virtual collider, performing force analysis on the line collider and the first virtual collider by using physics principles to obtain motion states (including information such as velocities, accelerations, and positions) of the line collider and the first virtual collider at a plurality of times after the collision, so that the first motion trajectory of the line collider after the collision and the second motion trajectory of the first virtual collider after the collision are obtained based on the motion states at the plurality of times. In this embodiment, the way of detecting whether the at least one selected from the group consisting of the line collider and the first virtual collider collides with the second virtual collider may be any collision detection way in the related art. Exemplarily, FIG. 3 is an example diagram of a scene in this embodiment. As shown in FIG. 3, the first virtual collider is a virtual stone, the line collider is generated according to the trajectory drawn by the user, and the second virtual collider is a virtual human body. The line collider and the first virtual collider are in free falling motion and collide with each other in the motion process. In this embodiment, the accuracy of collision detection can be improved by determining the first motion trajectory of the line collider after the collision and the second motion trajectory of the first virtual collider after the collision.

S140: generating a first result.

For example, the first result may be “failed challenging”. In this embodiment, when the at least one selected from the group consisting of the line collider and the first virtual collider collides with the second virtual collider, it indicates that the line collider drawn by the user has not completed a challenge task, and the result of “failed challenging” is generated.

Optionally, after the first result is generated, the image processing method further includes the following step: popping up a selection window for returning to the current scene for the user to select to return to the current scene.

In this embodiment, after the “failed challenging”, the user may select to return to the current scene to continue the challenge.

S150: generating a second result.

For example, the second result may be “successful challenging”. In this embodiment, when the at least one selected from the group consisting of the line collider and the first virtual collider does not collide with the second virtual collider, it indicates that the line collider drawn by the user has completed the challenge task, and the result of “successful challenging” is generated.

Optionally, after the second result is generated, the image processing method further includes the following step: popping up a selection window for jumping to next scene for the user to select to jump to next scene.

In this embodiment, after the “successful challenging”, the user may select next scene to challenge.

According to the technical solution of this embodiment: the line collider is generated according to the drawing trajectory triggered by the user in the screen corresponding to the current scene, the current scene includes a plurality of virtual colliders, and the line collider is constituted by a plurality of box colliders in a set shape; the line collider and a first virtual collider in the current scene are controlled to move in a set manner; whether at least one selected from the group consisting of the line collider and the first virtual collider collides with the second virtual collider is detected; in response to a collision, a first result is generated; and in response to no collision, a second result is generated. The image processing method provided in the embodiment of the present disclosure may generate the line collider constituted by a plurality of box colliders with the set shape based on the drawing trajectory triggered by the user and can realize processing of line colliders and improve the diversity of game development.

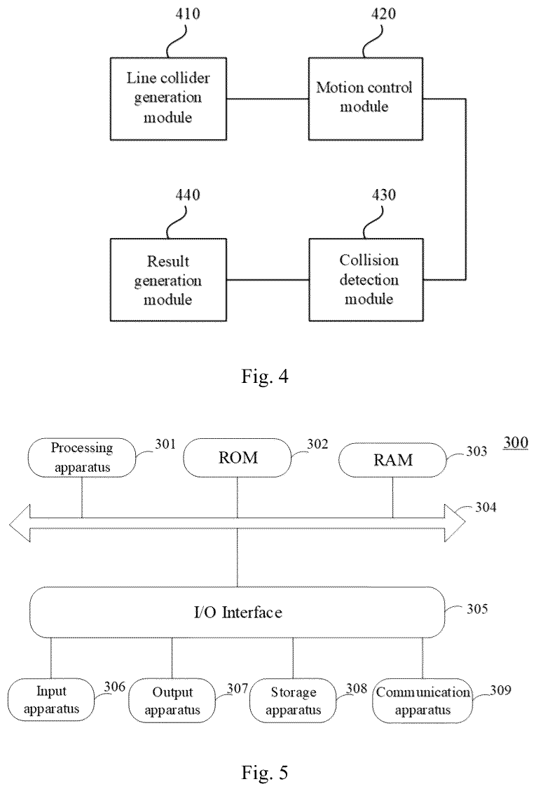

FIG. 4 is a structural schematic diagram of an image processing apparatus provided by an embodiment of the present disclosure. As shown in FIG. 4, the image processing apparatus includes:
a line collider generation module 410, configured to generate a line collider according to a drawing trajectory triggered by a user in a screen corresponding to a current scene, where the current scene includes a plurality of virtual colliders, and the line collider is constituted by a plurality of box colliders with a set shape;
a motion control module 420, configured to control the line collider and a first virtual collider in the current scene to move in a set manner;
a collision detection module 430, configured to detect whether at least one selected from the group consisting of the line collider and the first virtual collider collides with a second virtual collider; and
a result generation module 440, configured to generate a first result in response to the at least one selected from the group consisting of the line collider and the first virtual collider colliding with the second virtual collider, and generate a second result in response to the at least one of the line collider and the first virtual collider not colliding with the second virtual collider.

Optionally, the method further includes a second virtual collider generation module, which is configured to:
fuse an image with the second virtual collider to obtain a new second virtual collider. The image is a static image or a dynamic image.

Optionally, the line collider generation module 410 is further configured to:
in response to a drawing time reaching a timing end time, generate the line collider according to the drawing trajectory completed by the user in the screen corresponding to the current scene; or
in response to detecting that the user stopping drawing, generate the line collider according to the drawing trajectory completed by the user in the screen corresponding to the current scene.

Optionally, the line collider generation module 410 is further configured to:
acquire touch-screen points of every two adjacent frames of the user in a drawing process as a first touch-screen point and a second touch-screen point;
take the first touch-screen point and the second touch-screen point as two vertices with the set shape to generate a box collider with the set shape, and obtain a plurality of box colliders; and connect the plurality of box colliders in series to obtain the line collider.

Optionally, the line collider generation module 410 is further configured to:
in response to a transverse distance between the first touch-screen point and the second touch-screen point being greater than a set proportion of a transverse length of the screen, and/or, in response to a longitudinal distance between the first touch-screen point and the second touch-screen point being greater than a set proportion of a longitudinal length of the screen, insert a touch-screen point between the first touch-screen point and the second touch-screen point; and
generate the box collider with the set shape based on two adjacent touch-screen points after point insertion.

Optionally, the line collider generation module 410 is further configured to:
acquire a connecting line between the first touch-screen point and the second touch-screen point; and
insert at least one touch-screen point on the connecting line by adopting a set standard. The set standard is that a transverse distance between adjacent touch-screen points is less than or equal to the set proportion of the transverse length of the screen, and a longitudinal distance between adjacent touch-screen points is less than or equal to the set proportion of the longitudinal length of the screen.

Optionally, the line collider generation module 410 is further configured to:
in response to the drawing trajectory passing through a virtual collider in the current scene, acquire an overlapping area between the drawing trajectory and the virtual collider; and
skip over the overlapping area when generating the box collider with the set shape.

Optionally, the collision detection module 430 is further configured to:
in response to a collision between the line collider and the first virtual collider, determine a first motion trajectory of the line collider after the collision and a second motion trajectory of the first virtual collider after the collision;
control the line collider to continue moving according to the first motion trajectory, and control the first virtual collider to continue moving according to the second motion trajectory; and
detect whether the at least one selected from the group consisting of the line collider and the first virtual collider collides with the second virtual collider after continuing to move.

Optionally, the collision detection module 430 is further configured to:
detect whether the at least one selected from the group consisting of the line collider and the first virtual collider collides with the second virtual collider within a set duration.

Optionally, the method further includes a selection window popping-up module, which is configured to:
after generating the first result, pop up a selection window for returning to the current scene for the user to select to return to current scene; and
after generating the second result, pop up a selection window for jumping to next scene for the user to select to jump to next scene.

The apparatus described above may perform the image processing method provided in all the foregoing embodiments of the present disclosure and has corresponding functional modules for performing the image processing method and beneficial effects. For technical details not described in detail in this embodiment, a reference may be made to the image processing method provided in all the foregoing embodiments of the present disclosure.

Referring to FIG. 5, FIG. 5 illustrates a schematic structural diagram of an electronic device 300 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or various forms of servers, such as independent servers or server clusters. The electronic device illustrated in FIG. 5 is merely an example, and should not pose any limitation to the functions and the range of use of the embodiments of the present disclosure.

As illustrated in FIG. 5, the electronic device 300 may include a processing apparatus 301 (e.g., a central processing unit, a graphics processing unit, etc.), which can perform various suitable actions and processing according to a program stored in a read-only memory (ROM) 302 or a program loaded from a storage apparatus 308 into a random-access memory (RAM) 303. The RAM 303 further stores various programs and data required for operations of the electronic device 300. The processing apparatus 301, the ROM 302, and the RAM 303 are interconnected by means of a bus 304. An input/output (I/O) interface 305 is also connected to the bus 304.

Usually, the following apparatus may be connected to the I/O interface 305: an input apparatus 306 including, for example, a touch screen, a touch pad, a keyboard, a mouse, a camera, a microphone, an accelerometer, a gyroscope, or the like; an output apparatus 307 including, for example, a liquid crystal display (LCD), a loudspeaker, a vibrator, or the like; a storage apparatus 308 including, for example, a magnetic tape, a hard disk, or the like; and a communication apparatus 309. The communication apparatus 309 may allow the electronic device 300 to be in wireless or wired communication with other devices to exchange data. While FIG. 5 illustrates the electronic device 300 having various apparatuses, it should be understood that not all of the illustrated apparatuses are necessarily implemented or included. More or fewer apparatuses may be implemented or included alternatively.

In an embodiment, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 309 and installed, or may be installed from the storage apparatus 308, or may be installed from the ROM 302. When the computer program is executed by the processing apparatus 301, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries at least one program, and when the at least one program is executed by the electronic device, the electronic device is caused to: generate a line collider according to a drawing trajectory triggered by a user in a screen corresponding to a current scene, wherein the current scene includes a plurality of virtual colliders, and the line collider is constituted by a plurality of box colliders with a set shape; control the line collider and a first virtual collider in the current scene to move in a set manner; detect whether at least one selected from the group consisting of the line collider and the first virtual collider collides with a second virtual collider; and generate a first result in response to the at least one selected from the group consisting of the line collider and the first virtual collider colliding with the second virtual collider, and generate a second result in response to the at least one selected from the group consisting of the line collider and the first virtual collider not colliding with the second virtual collider.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with at least one wire, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the embodiment of the present disclosure, the embodiment of the present disclosure discloses an image processing method, including:
generating a line collider according to a drawing trajectory triggered by a user in a screen corresponding to a current scene, wherein the current scene includes a plurality of virtual colliders, and the line collider is constituted by a plurality of box colliders with a set shape;
controlling the line collider and a first virtual collider in the current scene to move in a set manner;
detecting whether at least one selected from the group consisting of the line collider and the first virtual collider collides with a second virtual collider; and
generating a first result in response to the at least one selected from the group consisting of the line collider and the first virtual collider colliding with the second virtual collider, and generating a second result in response to the at least one selected from the group consisting of the line collider and the first virtual collider not colliding with the second virtual collider.

Further, before generating the line collider according to the drawing trajectory triggered by the user in the screen corresponding to the current scene, the method further including:
fusing an image with the second virtual collider to obtain a new second virtual collider. The image is a static image or a dynamic image.

Further, generating the line collider according to the drawing trajectory triggered by the user in the screen corresponding to the current scene includes:
in response to a drawing time reaching a timing end time, generating the line collider according to the drawing trajectory completed by the user in the screen corresponding to the current scene; or
in response to detecting that the user stopping drawing, generating the line collider according to the drawing trajectory completed by the user in the screen corresponding to the current scene.

Further, generating the line collider according to the drawing trajectory triggered by the user in the screen corresponding to the current scene includes:
acquiring touch-screen points of every two adjacent frames of the user in a drawing process as a first touch-screen point and a second touch-screen point;
taking the first touch-screen point and the second touch-screen point as two vertices with the set shape to generate a box collider with the set shape, and obtaining a plurality of box colliders; and
connecting the plurality of box colliders in series to obtain the line collider.

Further, taking the first touch-screen point and the second touch-screen point as the two vertices with the set shape to generate the box collider with the set shape includes:
in response to a transverse distance between the first touch-screen point and the second touch-screen point being greater than a set proportion of a transverse length of the screen, and/or, in response to a longitudinal distance between the first touch-screen point and the second touch-screen point being greater than a set proportion of a longitudinal length of the screen, inserting a touch-screen point between the first touch-screen point and the second touch-screen point; and
generating the box collider with the set shape based on two adjacent touch-screen points after point insertion.

Further, inserting the touch-screen point between the first touch-screen point and the second touch-screen point includes:
acquiring a connecting line between the first touch-screen point and the second touch-screen point; and
inserting at least one touch-screen point on the connecting line by adopting a set standard. The set standard is that a transverse distance between adjacent touch-screen points is less than or equal to the set proportion of the transverse length of the screen, and a longitudinal distance between adjacent touch-screen points is less than or equal to the set proportion of the longitudinal length of the screen.

Further, generating the line collider according to the drawing trajectory triggered by the user in the screen corresponding to the current scene includes:
in response to the drawing trajectory passing through a virtual collider in the current scene, acquiring an overlapping area between the drawing trajectory and the virtual collider; and
skipping over the overlapping area when generating the box collider with the set shape.

Further, detecting whether the at least one selected from the group consisting of the line collider and the first virtual collider collides with the second virtual collider includes:
in response to a collision between the line collider and the first virtual collider, determining a first motion trajectory of the line collider after the collision and a second motion trajectory of the first virtual collider after the collision;
controlling the line collider to continue moving according to the first motion trajectory, and controlling the first virtual collider to continue moving according to the second motion trajectory; and
detecting whether the at least one selected from the group consisting of the line collider and the first virtual collider collides with the second virtual collider after continuing to move.

Further, detecting whether the at least one selected from the group consisting of the line collider and the first virtual collider collides with the second virtual collider includes:
detecting whether the at least one selected from the group consisting of the line collider and the first virtual collider collides with the second virtual collider within a set duration.

Further, after generating the first result, further including:
popping up a selection window for returning to the current scene for the user to select to return to the current scene; and
after generating the second result, the method further including:
popping up a selection window for jumping to next scene for the user to select to jump to next scene.

It will be appreciated that steps may be rearranged, added or deleted using various forms of flows as shown above. For example, the steps described in the present disclosure may be performed concurrently, performed sequentially or performed in different orders as long as the desired results of the technical solutions of the present disclosure can be achieved.

1. An image processing method, comprising:
generating a line collider according to a drawing trajectory triggered by a user in a screen corresponding to a current scene, wherein the current scene comprises a plurality of virtual colliders, and the line collider comprises a plurality of box colliders with a set shape;
controlling the line collider and a first virtual collider in the current scene to move in a set manner;
detecting whether at least one selected from the group consisting of the line collider and the first virtual collider collides with a second virtual collider; and
generating a first result in response to the at least one selected from the group consisting of the line collider and the first virtual collider colliding with the second virtual collider, and generating a second result in response to the at least one selected from the group consisting of the line collider and the first virtual collider not colliding with the second virtual collider.

2. The method according to claim 1, before generating the line collider according to the drawing trajectory triggered by the user in the screen corresponding to the current scene, the method further comprising:
fusing an image with the second virtual collider to obtain a fused second virtual collider, wherein the image comprises a static image or a dynamic image.

3. The method according to claim 1, wherein generating the line collider according to the drawing trajectory triggered by the user in the screen corresponding to the current scene comprises:
in response to a drawing time reaching a timing end time, generating the line collider according to the drawing trajectory completed by the user in the screen corresponding to the current scene; or
in response to detecting that the user stopping drawing, generating the line collider according to the drawing trajectory completed by the user in the screen corresponding to the current scene.

4. The method according to claim 1, wherein generating the line collider according to the drawing trajectory triggered by the user in the screen corresponding to the current scene comprises:
acquiring touch-screen points of every two adjacent frames of the user in a drawing process as a first touch-screen point and a second touch-screen point;
taking the first touch-screen point and the second touch-screen point as two vertices with the set shape to generate a box collider with the set shape, and obtaining a plurality of box colliders; and
connecting the plurality of box colliders in series to obtain the line collider.

5. The method according to claim 4, wherein taking the first touch-screen point and the second touch-screen point as the two vertices with the set shape to generate the box collider with the set shape comprises:
in response to a transverse distance between the first touch-screen point and the second touch-screen point being greater than a set proportion of a transverse length of the screen, and/or, in response to a longitudinal distance between the first touch-screen point and the second touch-screen point being greater than a set proportion of a longitudinal length of the screen, inserting a touch-screen point between the first touch-screen point and the second touch-screen point; and
generating the box collider with the set shape based on two adjacent touch-screen points after point insertion.

6. The method according to claim 5, wherein inserting the touch-screen point between the first touch-screen point and the second touch-screen point comprises:
acquiring a connecting line between the first touch-screen point and the second touch-screen point; and
inserting at least one touch-screen point on the connecting line by adopting a set standard, wherein the set standard is that a transverse distance between adjacent touch-screen points is less than or equal to the set proportion of the transverse length of the screen, and a longitudinal distance between adjacent touch-screen points is less than or equal to the set proportion of the longitudinal length of the screen.

7. The method according to claim 4, wherein generating the line collider according to the drawing trajectory triggered by the user in the screen corresponding to the current scene comprises:
in response to the drawing trajectory passing through a virtual collider in the current scene, acquiring an overlapping area between the drawing trajectory and the virtual collider; and
skipping over the overlapping area when generating the box collider with the set shape.

8. The method according to claim 1, wherein detecting whether the at least one selected from the group consisting of the line collider and the first virtual collider collides with the second virtual collider comprises:
in response to a collision between the line collider and the first virtual collider, determining a first motion trajectory of the line collider after the collision and a second motion trajectory of the first virtual collider after the collision;
controlling the line collider to continue moving according to the first motion trajectory, and controlling the first virtual collider to continue moving according to the second motion trajectory; and
detecting whether the at least one selected from the group consisting of the line collider and the first virtual collider collides with the second virtual collider after continuing to move.

9. The method according to claim 1, wherein detecting whether the at least one selected from the group consisting of the line collider and the first virtual collider collides with the second virtual collider comprises:
detecting whether the at least one selected from the group consisting of the line collider and the first virtual collider collides with the second virtual collider within a set duration.

10. The method according to claim 9, after generating the first result, further comprising:
popping up a selection window for returning to the current scene for the user to select to return to the current scene; and
after generating the second result, the method further comprising:
popping up a selection window for jumping to next scene for the user to select to jump to next scene.

11. (canceled)

12. An electronic device, comprising:
a processing apparatus; and
a storage apparatus, configured to store a program,
wherein the program, when executed by the processing apparatus, causes the processing apparatus to implement an image processing method; wherein the image processing method comprises:
generating a line collider according to a drawing trajectory triggered by a user in a screen corresponding to a current scene, wherein the current scene comprises a plurality of virtual colliders, and the line collider comprises a plurality of box colliders with a set shape;
controlling the line collider and a first virtual collider in the current scene to move in a set manner;
detecting whether at least one selected from the group consisting of the line collider and the first virtual collider collides with a second virtual collider; and
generating a first result in response to the at least one selected from the group consisting of the line collider and the first virtual collider colliding with the second virtual collider, and generating a second result in response to the at least one selected from the group consisting of the line collider and the first virtual collider not colliding with the second virtual collider.

13. A non-transitory computer-readable medium, storing a computer program, wherein the computer program, when executed by a processing apparatus, causes to implement an image processing method; wherein the image processing method comprises:
generating a line collider according to a drawing trajectory triggered by a user in a screen corresponding to a current scene, wherein the current scene comprises a plurality of virtual colliders, and the line collider comprises a plurality of box colliders with a set shape;
controlling the line collider and a first virtual collider in the current scene to move in a set manner;
detecting whether at least one selected from the group consisting of the line collider and the first virtual collider collides with a second virtual collider; and
generating a first result in response to the at least one selected from the group consisting of the line collider and the first virtual collider colliding with the second virtual collider, and generating a second result in response to the at least one selected from the group consisting of the line collider and the first virtual collider not colliding with the second virtual collider.

14. The method according to claim 3, wherein generating the line collider according to the drawing trajectory triggered by the user in the screen corresponding to the current scene comprises:
acquiring touch-screen points of every two adjacent frames of the user in a drawing process as a first touch-screen point and a second touch-screen point;
taking the first touch-screen point and the second touch-screen point as two vertices with the set shape to generate a box collider with the set shape, and obtaining a plurality of box colliders; and
connecting the plurality of box colliders in series to obtain the line collider.

15. The electronic device according to claim 12, before generating the line collider according to the drawing trajectory triggered by the user in the screen corresponding to the current scene, wherein the method further comprises:
fusing an image with the second virtual collider to obtain a fused second virtual collider, wherein the image comprises a static image or a dynamic image.

16. The electronic device according to claim 12, wherein generating the line collider according to the drawing trajectory triggered by the user in the screen corresponding to the current scene comprises:
in response to a drawing time reaching a timing end time, generating the line collider according to the drawing trajectory completed by the user in the screen corresponding to the current scene; or
in response to detecting that the user stopping drawing, generating the line collider according to the drawing trajectory completed by the user in the screen corresponding to the current scene.

17. The electronic device according to claim 12, wherein generating the line collider according to the drawing trajectory triggered by the user in the screen corresponding to the current scene comprises:
acquiring touch-screen points of every two adjacent frames of the user in a drawing process as a first touch-screen point and a second touch-screen point;
taking the first touch-screen point and the second touch-screen point as two vertices with the set shape to generate a box collider with the set shape, and obtaining a plurality of box colliders; and
connecting the plurality of box colliders in series to obtain the line collider.

18. The electronic device according to claim 17, wherein taking the first touch-screen point and the second touch-screen point as the two vertices with the set shape to generate the box collider with the set shape comprises:
in response to a transverse distance between the first touch-screen point and the second touch-screen point being greater than a set proportion of a transverse length of the screen, and/or, in response to a longitudinal distance between the first touch-screen point and the second touch-screen point being greater than a set proportion of a longitudinal length of the screen, inserting a touch-screen point between the first touch-screen point and the second touch-screen point; and
generating the box collider with the set shape based on two adjacent touch-screen points after point insertion.

19. The electronic device according to claim 18, wherein inserting the touch-screen point between the first touch-screen point and the second touch-screen point comprises:
acquiring a connecting line between the first touch-screen point and the second touch-screen point; and
inserting at least one touch-screen point on the connecting line by adopting a set standard, wherein the set standard is that a transverse distance between adjacent touch-screen points is less than or equal to the set proportion of the transverse length of the screen, and a longitudinal distance between adjacent touch-screen points is less than or equal to the set proportion of the longitudinal length of the screen.

20. The electronic device according to claim 17, wherein generating the line collider according to the drawing trajectory triggered by the user in the screen corresponding to the current scene comprises:
in response to the drawing trajectory passing through a virtual collider in the current scene, acquiring an overlapping area between the drawing trajectory and the virtual collider; and
skipping over the overlapping area when generating the box collider with the set shape.

21. The electronic device according to claim 12, wherein detecting whether the at least one selected from the group consisting of the line collider and the first virtual collider collides with the second virtual collider comprises:
in response to a collision between the line collider and the first virtual collider, determining a first motion trajectory of the line collider after the collision and a second motion trajectory of the first virtual collider after the collision;
controlling the line collider to continue moving according to the first motion trajectory, and controlling the first virtual collider to continue moving according to the second motion trajectory; and
detecting whether the at least one selected from the group consisting of the line collider and the first virtual collider collides with the second virtual collider after continuing to move.
